(19) United States
(12) Patent Application Publication
(10) Pub. No.: US 2007/0267960 A1
(43) Pub. Date: Nov. 22, 2007

(54) Phosphor Blend and Lamp Containing Same

(75) Inventors: Madis Raukas, Charlestown, MA (US); Richard S. Speer, Concord, MA (US); Philip E. Moskowitz, Georgetown, MA (US)

Correspondence Address: OSRAM SYLVANIA INC, 100 ENDICOTT STREET, DANVERS, MA, 01923, US

(73) Assignee: OSRAM SYLVANIA INC., Danvers, MA (US)

(21) Appl. No.: 11/749,893

(22) Filed: May 17, 2007

Related U.S. Application Data
(60) Provisional application No. 60/747,617, filed on May 18, 2006.

(51) Int. Cl. H01J 63/04; H01J 1/62

(52) U.S. Cl. 313/485; 313/503

(57) ABSTRACT

A phosphor blend for use with an indium halide discharge lamp and a lamp made therewith is described. The phosphor blend comprising at least two phosphors selected from Ca₈Mg(SiO₄)₄Cl₂:Eu, SrSi₂N₂O₂:Eu and Ca₂Si₅N₈:Eu: The blend may also include a blue-emitting phosphor such as BaMgAl₁₀O₁₇:Eu.

### CROSS REFERENCES TO RELATED APPLICATIONS

This application claims the benefit of U.S. Provisional Application No. 60/747,617, filed May 18, 2006.

### BACKGROUND OF THE INVENTION

The use of mercury in common mass-produced products is declining because of environmental concerns and increased governmental regulation. This trend keenly affects the lighting industry since mercury has been a primary material in the manufacture of lamps for decades, particularly fluorescent lamps.

In view of this, recent efforts have been made to reduce or eliminate mercury in florescent lamps. For example, PCT Patent Application No. WO 02/103748 describes a low-pressure gas discharge lamp based on an indium-containing gas filling. In particular, the lamp contains an indium halide, e.g., indium chloride, and an inert gas. The radiation emitted by the discharge has emission bands around 304, 325, 410 and 451 nm, as well as a continuous molecular spectrum in the visible blue range. A number of phosphors are listed for supplementing the radiation from the discharge in order to obtain white light. PCT Patent Application No. WO 2005/0456881 extends the list of available phosphors to use with the indium halide discharge to nitridosilicate and oxonitridosilicate phosphors.

However, it is not sufficient to just produce a white light emission. Most lighting applications today require energy efficient lamps that emit white light having a good color rendering index (CRI), preferably greater than 80. Correlated color temperatures (CCT) between 3000K and 7000K are also preferred, in particular 3000K to 5500K. Unfortunately, the aforementioned references do not teach how to achieve such results with an indium halide discharge. Thus, it would be advantageous to develop phosphor blends to use with an indium halide discharge to produce a white emission and preferably a white emission having a desirable CRI or CCT.

### SUMMARY OF THE INVENTION

The strongly blue-emitting, indium halide discharge shows superior emission properties and potentially good efficacy values from a white light production point of view, with only one major drawback. In addition to atomic and molecular emissions in near-UV range, there are two emission lines located very close to each other at 411 and 451 nm that have an approximate output power ratio of 40%-60%. While the blue 451 nm emission is nearly perfect for white light as a blue component, the violet radiation at 411 nm results in negligible lumens and very little effect on color rendering.

Radiation from the entire output spectrum of the discharge can be utilized by converting parts of it to the visible range with suitably chosen phosphors that have their excitation (sensitivity) extending to violet and blue wavelengths. These include in particular the red-emitting phosphor Ca₂Si₅N₈:Eu (Ca—SiN) and the green-emitting phosphors SrSi₂N₂O₂:Eu (Sr—SiON) and Ca₈Mg(SiO₄)₄Cl₂:Eu (CAM-Si). The excitation of these phosphors provides a far better overlap with the discharge emission than, for example, YAG:Ce.

The composition of the phosphor blends of this invention may be represented by the weight fractions of the phosphor components in the different blends, usually expressed as a range of values. The three phosphor components are represented for the sake of convenience as X, Y and Z where X is Ca₈Mg(SiO₄)₄Cl₂:Eu, Y is SrSi₂N₂O₂:Eu and Z is Ca₂Si₅N₈:Eu:

In one embodiment, the phosphor blend has a composition wherein the weight fractions of the phosphor components are 0.15<X<0.85, 0.85>Z>0.15 and X+Z=1.

In another embodiment, the phosphor blend has a composition wherein the weight fractions of the phosphor components are 0.15<Y<0.85, 0.85>Z>0.15 and Y+Z=1.

In yet another embodiment, the phosphor blend has a composition wherein the weight fractions of the phosphor components are 0.15<(X+Y)<0.85, 0.85>Z>0.15 and X+Y+Z=1.

In a preferred embodiment, the phosphor blend has a composition wherein the weight fractions of the phosphor components are 0.25<Z<0.75, 0.75>(X+Y)>0.25, and wherein 0.75(X)<Y<1.5(X) and X+Y+Z=1.

In a more preferred embodiment, the phosphor blend has a composition wherein the weight fractions of the phosphor components are 0.55<Z<0.75, 0.1<X<0.25, 0.1<Y<0.25, and X+Y+Z=1.

In an alternative embodiment, a blue-emitting phosphor, preferably BaMgAl₁₀O₁₇:Eu (BAM), is added as a fourth component, W, and the phosphor blend has a composition wherein the weight fractions of the phosphor components are 0.40<Z<0.65, 0.1<X<0.30, 0.1<Y<0.30, 0.01<W<0.15 and X+Y+Z+W=1

### BRIEF DESCRIPTION OF THE DRAWINGS

FIG. 1 is a graph of the spectral power distribution of an indium chloride (InCl) discharge.

FIG. 2 shows emission spectra of the four phosphor components at 250 nm excitation: BAM (thick solid), CAM-Si (dashed), Sr—SiON (solid) and Ca—SiN (dotted line).

FIG. 3 shows excitation spectra of CAM-Si, Ca—SiN, Sr—SiON and BAM (PDP). Normalization corresponds to integrated total emission under 250 nm excitation.

FIG. 4 shows a simulated lamp output spectrum (scaled area-normalized components) based on a 33% intensity contribution from an InCl discharge, a 10% intensity contribution from a CAM-Si phosphor, a 16% intensity contribution from a Sr—SiON phosphor and a 41% intensity contribution from an Ca—SiN phosphor, the simulated spectrum having a CCT of 4867K and CRI of 88.

FIG. 5 shows the relative amount of 450 nm blue light passed through experimental, unbaked slides as a function of coating density.

FIG. 6 shows the emission from a slide with a 2.08 mg/cm² coating density under InCl lamp excitation.

FIG. 7 is a cross-sectional illustration of a lamp containing a phosphor blend according to this invention.

### DETAILED DESCRIPTION OF THE INVENTION

For a better understanding of the present invention, together with other and further objects, advantages and capabilities thereof, reference is made to the following disclosure and appended claims taken in conjunction with the above-described drawings.

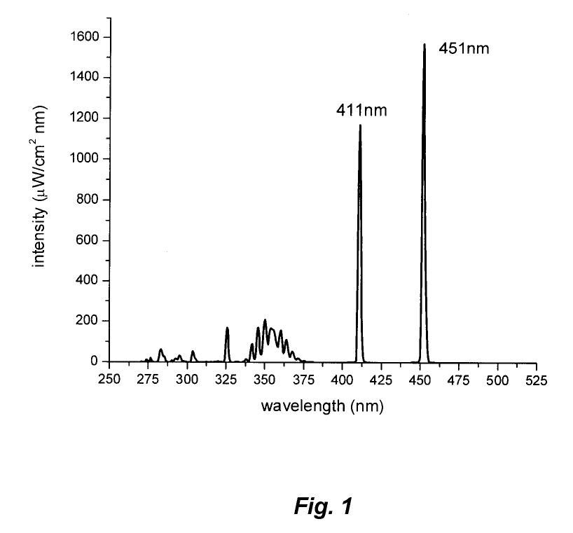

The emission spectrum of an indium chloride (InCl) discharge is presented in FIG. 1. The spectrum has multiple atomic emission lines of In as well as molecular vibrational bands at around 350 nm, the other lines and continua being much weaker. The main emission peaks occur at 451 nm and 411 nm. Thus, phosphors potentially applicable to this situation must not only absorb ultraviolet (UV) radiation but also violet and blue radiation in order to make use of most of the emitted radiation. This involves a delicate job of balancing the absorption and transmission of discharge emission by the phosphor coating. The cumulative white emission from the lamp is expected to be a mixture of blue radiation passing through the phosphor layer and the radiation emitted by the phosphor coating itself.

There is in principle more than one way of achieving white emission from such a lamp, the main differences being in the number of phosphor components used in the phosphor blend. The simplest of these is to convert part of the blue emission from the discharge into the yellow-orange spectral range by means of only one phosphor component, e.g., a blue-absorbing, yellow-emitting Y₃Al₅O₁₂:Ce (YAG:Ce) phosphor. However, the result is a relatively low-grade white light. For a high-grade white light, more than one phosphor component would be needed for a good CRI and CCT, preferably including sufficient amounts of a red-emitting phosphor.

The next option would therefore be a two-phosphor blend of green- and red-emitting phosphors that utilizes blue light from the discharge for both excitation and as a color component. More preferably, the phosphor blend would have three or more phosphors, including a blue-emitting phosphor, in order to have a better control over emission parameters.

It is clear from FIG. 1 that passing part of the blue emission from the discharge through the phosphor layer also means inevitably passing a portion of the 411 nm radiation because of the relatively small separation between the two major lines. This is because the typical absorption onset of a phosphor does not constitute a step function. Unfortunately, the 411 nm emission contributes negligibly to both the color and lumen output of the lamp. One would expect that the optimum use of discharge radiation would thus require a complete absorption of the near zero-lumen 411 nm line by the phosphor blend. In turn, this would reduce the transmitted blue light to a level far below the level needed to produce a pleasant, high-color-rendering white light. Hence, a blue phosphor component would have to be added to the phosphor blend.

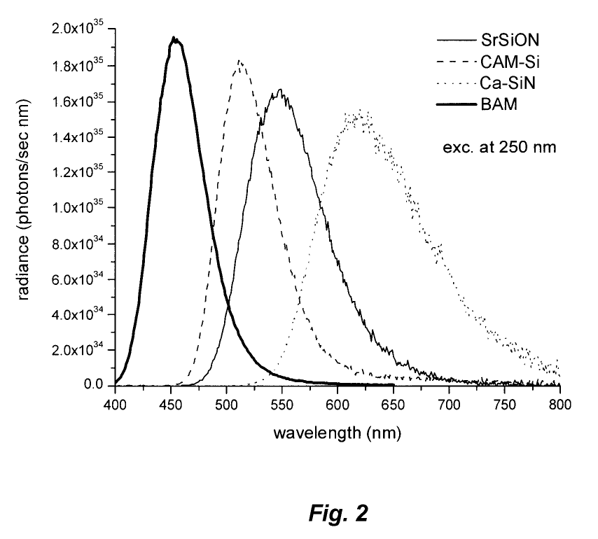

Phosphors suitable for excitation by the blue radiation emitted by an indium halide discharge include, but are not limited to, red-emitting Ca₂Si₅N₈:Eu (Ca—SiN), green-emitting SrSi₂N₂O₂:Eu (Sr—SiON) and blue-green-emitting Ca₈Mg(SiO₄)₄Cl₂:Eu (CAM-Si). In all of the above-mentioned phosphors, the emission is based on Eu²⁺ activation, exhibiting broad bands peaking at 620 nm, 547 nm and 513 nm, respectively (see FIG. 2). For the blue-emitting phosphor, a BaMgAl₁₀O₁₇:Eu (BAM) phosphor also could be used, which has an emission that peaks at 450 nm. However, the Sr-based counterpart, SrMgAl₁₀O₁₇:Eu (SAM) with a peak emission at 467 nm may be slightly more favorable because of its absorption and reflectance characteristics. Another possible blue-emitting phosphor is Sr₅(PO₄)₆Cl:Eu²⁺ (SCAP).

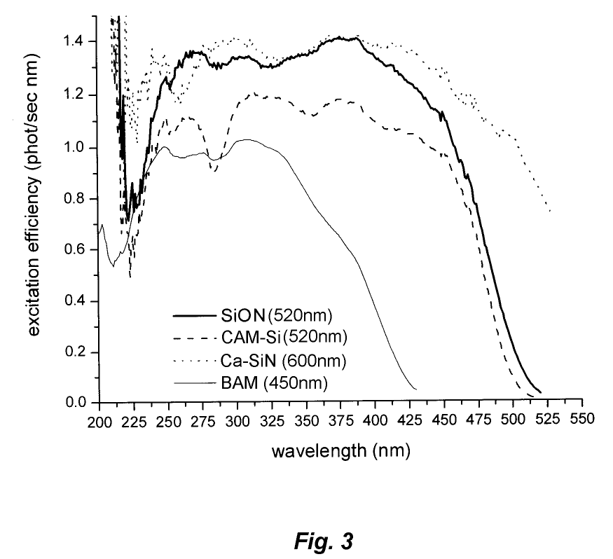

The excitation spectra of the CAM-Si, Ca—SiN, Sr—SiON and BAM phosphors are presented in FIG. 3. The first three phosphors have very good excitation efficiencies at 450 nm and shorter wavelengths. The BAM phosphor, which is optimized for Hg and Xe gas discharges, would have to be excited by the 411 nm and UV radiation emitted by the indium halide discharge. As can be seen from FIGS. 2 and 3, the re-absorption of the 450 nm emission of the BAM phosphor is likely to occur in a blend containing one or more of the other three phosphors. In addition, the red-emitting Ca—SiN phosphor absorbs into the green region of the visible spectrum.

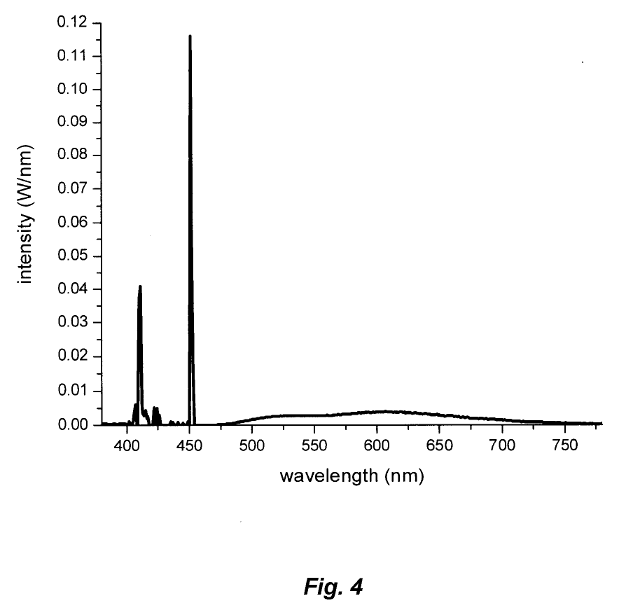

Using data from the emission measurements on the InCl discharge and the emission curves of each phosphor, an area-weighed combination of the violet/blue discharge lines and CAM-Si, Sr—SiON and Ca—SiN emissions was obtained. This result was further optimized for the highest CRI and appropriate CCT achievable (and maximum possible lumens thereby) by calculating these parameters and the corresponding color coordinates for a number of different, systematically varied combinations. The results are presented in Table 1 and the 88.1/4867K CRI/CCT spectrum (last line in Table 1) is shown in FIG. 4.

TABLE 1

| Discharge | CAM-Si | Sr—SiON | Ca—SiN | CCT | CRI | Rel. Im |
|---|---|---|---|---|---|---|
| 0.42 | — | 0.42 | 0.17 | 7588 | 69.4 | 0.76 |
| 0.25 | — | 0.50 | 0.25 | 4778 | 65.4 | 0.94 |
| 0.20 | 0.20 | 0.40 | 0.20 | 5530 | 66.5 | 1.00 |
| 0.19 | 0.21 | 0.35 | 0.25 | 5340 | 70.8 | 0.97 |
| 0.18 | 0.23 | 0.30 | 0.28 | 5209 | 74.9 | 0.94 |
| 0.16 | 0.21 | 0.27 | 0.36 | 4645 | 80.3 | 0.91 |
| 0.11 | 0.22 | 0.28 | 0.39 | 4315 | 79.8 | 0.96 |
| 0.24 | 0.19 | 0.24 | 0.33 | 5157 | 82.6 | 0.83 |
| 0.36 | 0.16 | 0.20 | 0.28 | 7211 | 85.9 | 0.71 |
| 0.32 | 0.14 | 0.18 | 0.36 | 5573 | 88.4 | 0.70 |
| 0.30 | 0.13 | 0.17 | 0.41 | 4768 | 90.5 | 0.70 |
| 0.36 | 0.11 | 0.18 | 0.35 | 6106 | 85.3 | 0.66 |
| 0.33 | 0.10 | 0.16 | 0.41 | 4867 | 88.1 | 0.68 |

With reference to Table 1, a strong blue contribution from the discharge emission seems to benefit both CCT and CRI output parameters. Also, it is important for good color rendering to have a noticeable fraction of the blend contain the red component.

A BAM phosphor (a plasma display panel (PDP) type) was used as a reference for QE at 250 nm and YAG:Ce (Type 251, OSRAM SYLVANIA Products Inc.) for 450 nm excitation. The strongest blue-absorbing phosphor is the Ca—SiN phosphor whose absorption extends far into the green range. None of the spectra has an abrupt, step-like onset of the absorption since the low-energy tail of these curves is a smoothly decaying function. This means that both 411 nm and 451 nm InCl discharge lines will pass through unless the lamp coating is optimized to stop the 411 nm radiation completely. The difference in transmission at these wavelengths may be crudely approximated by e^{-μ/β} where the exponent is the value of the remission function at the wavelength of interest. This yields only a difference of about 2.3 to 4.2 times in the transmission of the blue 451 nm line vs. the violet 411 nm line. In other words, in order to make complete use of the discharge, the coating has to be optimized for zero transmission at 411 nm, which would also reduce the blue radiation below the level required for good color rendering. As the 411 nm and 451 nm lines have an approximate 40%-60% integrated total emission ratio in pure discharge measurements, reducing the former to about a 1% intensity level leaves only 1.5% worth of intensity in the latter. A small modification to this caused by the absorption of phosphor layer will be demonstrated below.

Adding the blue-emitting phosphor component (e.g. BAM) would be necessary for correcting this issue. It is clear, however, from FIG. 2 that the blue emission of the phosphor will be partially reabsorbed by the other three components of the blend. Apart from some efficiency loss, it makes predicting the necessary emission intensity complicated, as some of the photons emitted by the blend may have undergone a double conversion—from violet/UV to blue and subsequently to green/red. Further, it is also clear that some of the green emission from CAM-Si and Sr—SiON phosphors will be re-absorbed by Ca—SiN phosphor; the latter having the longest absorption tail extending to about 550 nm where both green-emitting phosphors strongly emit. The implications of this are that the relative weight of red phosphor should be reduced. The re-absorption of visible light by a coating thick enough to make use of the entire 411 nm emission of the InCl discharge may lead to lower than expected lumen output. Test blending and coating of small experimental slides (see below) has yielded evidence for this case (see Tables 5 and 6).

Maximum Expected LPW_{UV} Values

Subsequently, it was attempted to estimate the lumen per watt (LPW) values for three phosphor components and two of the blend compositions of choice. Spectral distributions were normalized to 1 W of total power in the visible range (see Table 2). “Ideal” in this case means a blend of desired parameters (CRI, CCT) that, depending on the number of components (four or three), either does or does not contain BAM, respectively. The LPW₄₅₁ and LPW₄₁₁ for each column have been calculated from the corresponding emission spectrum assuming a certain quantum efficiency (QE) for generating the visible photons when excited by the 451 nm or 411 nm emission line of InCl.

TABLE 2
Maximum visible (LPW_{VIS}), blue (LPW₄₅₁) and
violet (LPW₄₁₁) efficacy values for three phosphor
components and two phosphor blends (one of them with and
without the contribution from InCl discharge)

| | CAM-Si | | | | | |
|---|---|---|---|---|---|---|
| | blue- | Sr—SiON | Ca—SiN | Ideal | Ideal blend | Ideal (4, |
| | green | green | red | blend (3) | (3 + discharge) | w/BAM) |
| VIS (W) | 1.0 | 1.0 | 1.0 | 1.0 | 1.0 | 1.0 |
| LPW_{VIS} | 418.2 | 518.6 | 237.6 | 345.3 | 201.2 | 325.0 |
| VIS | 2.66 | 2.82 | 3.21 | 3.01 | 2.60 | 2.94 |
| (ph/s × 10¹⁸) | | | | | | |
| QE | 0.9 | 0.9 | 0.9 | 0.9 | 1.0 and 0.9 | 0.9 |
| 451 nm | 2.96 | 3.13 | 3.57 | 3.34 | 2.89 | 3.27 |
| (ph/s × 10¹⁸) | | | | | | |
| 411 nm | 2.96 | 3.13 | 3.57 | 3.34 | 2.89 | 3.27 |
| (ph/s × 10¹⁸) | | | | | | |
| 451 nm(W) | 1.30 | 1.38 | 1.57 | 1.47 | n/a | 1.44 |
| 411 nm(W) | 1.43 | 1.51 | 1.72 | 1.62 | n/a | 1.58 |
| LPW₄₅₁ | 320.8 | 376.3 | 151.2 | 234.6 | n/a | 225.7 |
| LPW₄₁₁ | 292.3 | 343.0 | 137.8 | 213.8 | n/a | 205.7 |
| LPW_{40–60} | 309.4 | 360.0 | 145.9 | 226.3 | 159.1 | 217.7 |

The green-emitting Sr—SiON phosphor produces the highest visible lumens with 518.6 lm per each visible watt generated (2.82×10¹⁸ photons in total). With the assumed QE of 0.9, it takes about 10% more blue or violet photons to generate this green photon flux. For this, 1.38 W and 1.51 W of optical power at 451 nm and 411 nm, respectively, is required, yielding LPW₄₅₁=376.3 and LPW₄₁₁=343, respectively (i.e. all incident photons assumed to be concentrated at 451 nm or 411 nm wavelength). With the actual mix of excitation lines as 40-60%, the highest possible LPW value for this phosphor has been calculated as LPW₄₀₋₆₀=360. A proper blending with two other phosphor components reduces the value to 226.3 LPW₄₀₋₆₀. If the actual discharge plus blend emission spectrum is considered (FIG. 4, CRI=88 and CCT=4867K with part of the blue and violet transmitted at QE=1.0) then one is left with only about 159 LPW₄₀₋₆₀ as a theoretical maximum. As far as pure emission spectra are considered, this strongly lowered efficacy number can be improved again by entirely giving up the contribution of blue light from the discharge and replacing it with a blue emission from a phosphor (fourth component, e.g. BAM). Maximum theoretical LPW_{VIS} for a blend consisting of 10% BAM, 15% CAM-Si, 30% Sr—SiON and 45% Ca—SiN emissions (see Table 3, not fully optimized) yields 325 LPW_{VIS} and 226.3 LPW₄₀₋₆₀. The latter requires complete absorption of both 411 nm and 451 nm emissions from InCl discharge by the phosphor layer. It must also be noted that re-absorption of phosphor component emission has been included in this reasoning.

TABLE 3
Relative area-weighing coefficients for four phosphor emission
components and the resulting correlated color temperature
(CCT), color rendering index (CRI) and relative lumen values.

| BAM | CAM-Si | SiON | Ca—SiN | CCT | CRI | Rel. Im |
|---|---|---|---|---|---|---|
| 0.05 | 0.15 | 0.25 | 0.55 | 3347 | 84.0 | 0.9351 |
| 0.10 | 0.15 | 0.25 | 0.50 | 3681 | 87.0 | 0.9174 |
| 0.05 | 0.10 | 0.25 | 0.60 | 3005 | 85.0 | 0.9056 |
| 0.01 | 0.10 | 0.29 | 0.60 | 2989 | 74.8 | 0.95575 |
| 0.10 | 0.20 | 0.20 | 0.50 | 3826 | 89.4 | 0.90265 |
| 0.15 | 0.25 | 0.20 | 0.40 | 4731 | 86.6 | 0.9115 |
| 0.07 | 0.20 | 0.30 | 0.43 | 4064 | 77.9 | 1 |
| 0.10 | 0.15 | 0.30 | 0.45 | 3926 | 82.5 | 0.9587 |

Other Factors Influencing Blending

One of the disadvantages of the InCl discharge is the high operating temperature required for InCl emission. The wall temperature of the bulb may reach 200° C. or more. However, an infrared reflecting jacket around the lamp, and separated from it, will probably not exceed 150° C. This is the preferred surface for phosphor coating. Phosphors that have been coated on this jacket will have to tolerate this high operating temperature without a significant decrease in conversion efficiency. It is known for most of the phosphors used in various applications that the quantum efficiency will decrease at elevated temperatures due to an increase in non-radiative decay probability. Furthermore, the phosphors have to maintain their chemical (e.g. composition) and physical (e.g. structure) properties while heated to such temperatures in order to prevent the deterioration of their output. The temperature dependence of CAM-Si, Sr—SiON and Ca—SiN was measured under steady-state conditions of 365 nm excitation (Hg—Xe lamp with interference filter). The corresponding weight correction factors due to increased nonradiative processes at elevated temperatures have been incorporated into the blend recipes. One skilled in the art can readily determine these correction factors by empirical measurements.

Experimental Coating of Slides

Physical testing of phosphor blends was first attempted with three components (CAM-Si, Sr—SiON and Ca—SiN) only. Small slides of about 0.8″×1.0″ (20×25 mm²) were cut from regular microscope slides made of quartz and Pyrex. Some of these slides were sandblasted that increased the surface area for the coating but also caused strong scattering of the transmitted light. A preferred method of coating the phosphor blends on a glass substrate uses a slurry of the blend and a polyisobutyl-methacrylate (PIBMA) binder (Elvacite 2045). A vehicle of 13 wt. % PIBMA and 87 wt. % xylene was prepared. Dibutylphthalate and a surfactant (Armeen CD) were added in equal amounts of 1.5 wt. %. A 43 gram amount of the vehicle was mixed with 0.7 grams of a high surface area aluminum oxide powder (Aluminum Oxide C) and rolled for 24 hours. Slurries of the phosphor blends were made by mixing about 4 grams of the phosphor blends with 4-6 ml of the vehicle. The slurry is applied to the glass surface, dried and the binder removed by baking in a nitrogen atmosphere at about 350° C.

The values from Table 1 for the three mixed emission components (10% CAM-Si, 16% Sr—SiON and 41% Ca—SiN) after re-normalization (excluding the discharge) yield 15, 24 and 61%, respectively (Table 4). The next step would be to correct these values for the product of each phosphor's quantum efficiency with discharge intensity, integrated over the spectrum. It is a useful exercise but unfortunately limited to an approximation only due to the fact that excitation intensity is spread over UV and blue spectral regions where the phosphor response is not uniform. It is evident from Table 4 for example that the “match” between CAM-Si and the InCl discharge is relatively less optimal than for other two phosphors. Although not indicated in Table 4, YAG:Ce has a useful overlap of its excitation spectrum and the discharge of only about 53% compared to Sr—SiON.

The second correction comes from the different temperature dependence of each component as demonstrated earlier. Among the three, Sr—SiON is the least affected by temperature quenching. The cumulative values are reflected in the rightmost column of Table 4 and will be used as a starting point for the physical blending of powders.

TABLE 4
Correction factors for the three phosphors used in the blend.

| | From | | |
|---|---|---|---|
| | emission | | Cumulative |
| Phosphor | blending (%) | ∫QE(λ) * I_{dis}(λ) | (wt. %) |
| CAM-Si | 15 | ×1.18 | 18.5 |
| Sr—SiON | 24 | ×1.00 | 15.5 |
| Ca—SiN | 61 | ×1.01 | 66.0 |

In addition to the blend shown in Table 4 (designated as blend #1), additional combinations of CAM-Si/Sr—SiON/Ca—SiN were used having the proportions 20/20/60 wt. % (blend #2) and 15/13/72 wt. % (blend #3).

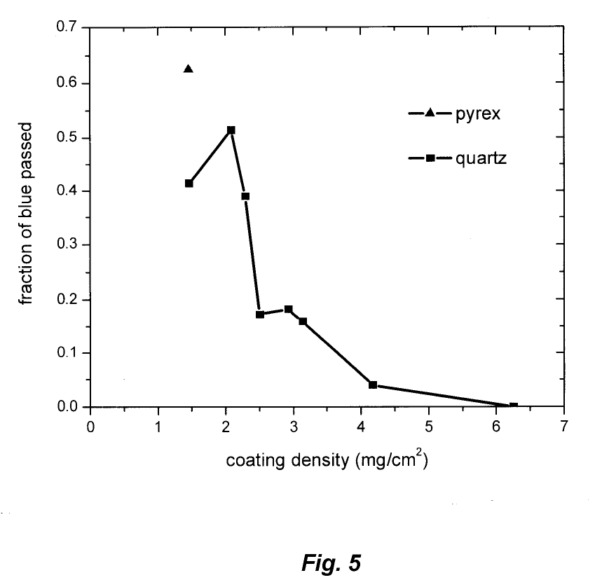

The blends were coated onto slides and after drying (but before baking), the optical density of the slides was checked by using a 450 nm LED and a fiber optic probe (Ocean Optics USB2000). The amount of blue light passed through slides (in peak intensity) was found to be a function of coating density. The dependence of transmitted blue light on the coating thickness is demonstrated in FIG. 5 (all of blend #2). Subsequently, the slides were baked at 350° C. for 20 minutes in a kiln purged by nitrogen.

TABLE 5
Optical parameters calculated from InCl excited spectra
of phosphor-coated slides as functions of coating density.
The intensity ratios are for peak values.

| Density | | | Rel. | I₄₅₁/ | | Blend #; |
|---|---|---|---|---|---|---|
| (mg/cm²) | CRI | CCT | lumens | Iₚₕₒₛₚₕₒᵣ | I₄₁₁/I₄₅₁ | slide |
| 0.00 | — | — | — | — | 0.75 | no slide |
| 10.2 | 44.3 | 1572 | 1.00 | 0.98 | 0.49 | 1; quartz |
| 10.6 | 42.8 | 1456 | 0.97 | 1.05 | 0.50 | 3; quartz |
| 13.3 | 43.3 | 1430 | 0.58 | 1.16 | 0.47 | 1; quartz |
| 13.8 | 44.0 | 1363 | 0.75 | 1.39 | 0.51 | 3; quartz |
| 15.8 | 47.5 | 1439 | 0.70 | 1.45 | 0.52 | 2; quartz |
| 16.9 | 48.9 | 1367 | 0.44 | 1.71 | 0.47 | 1; quartz |
| 21.0 | 49.4 | 1306 | 0.33 | 2.09 | 0.49 | 3; quartz |
| 22.3 | 51.9 | 1356 | 0.34 | 2.17 | 0.46 | 2; quartz |
| 31.9 | n/a | n/a | 0.23 | 12.74 | 0.57 | 1; quartz* |

*sand-blasted quartz

Testing the Slides

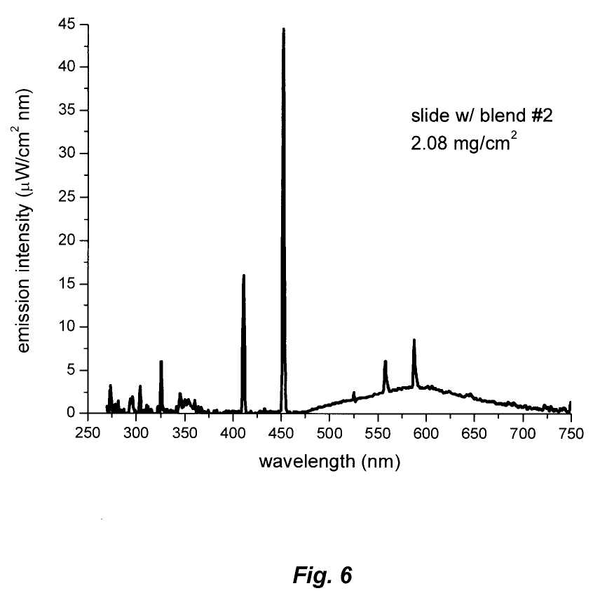

Optical characteristics were measured using InCl lamp excitation and a fiber optic probe. An outer hemispherical glass jacket contains a “shelf”, or circular ring which supports the phosphor test slides in close proximity to the InCl discharge (˜1 cm). The smaller spherical glass discharge bulb is concentric within this outer jacket, supported by thin glass tubes. In this way, the discharge can operate within an insulated, or jacketed, environment, and subject the slides to the UV/Blue discharge emission. An optical fiber protrudes into the jacket from outside via a hole in the glass, and thereby views the phosphor slide emission from the side opposite the discharge, as would be the case in an actual lamp environment. The slides exhibited a strongly varying ratio of transmitted blue discharge and phosphor emission intensities; the other parameters changed relatively less significantly, as evident from Table 6. An example spectrum recorded for the slide with 2.08 mg/cm² coating weight is presented in FIG. 6.

Optical parameters calculated from InCl excited spectra of phosphor-coated slides as functions of coating density are shown in Table 6. The intensity ratios are for peak values; I/I₀ is measured for unbaked slides, with 450 nm LED excitation as an indication of the blue transmitted. Relative lumen values have been obtained by normalizing to the maximum measured value in Table 5 (assuming the same experimental conditions).

TABLE 6

| Density | | | | I/I₀ | | | |
|---|---|---|---|---|---|---|---|
| (mg/ | | | Rel. | at | I₄₅₁/ | | |
| cm²) | CRI | CCT | lumens | 450 nm | Iₚₕₒₛₚₕₒᵣ | I₄₁₁/I₄₅₁ | Comment |
| 1.46 | 76.5 | 3873 | 3.80 | 0.63 | 16.1 | 0.39 | Pyrex |
| 1.46 | 74.1 | 3565 | 3.76 | 0.41 | 11.8 | 0.35 | quartz |
| 2.08 | 74.8 | 3717 | 3.19 | 0.51 | 14.2 | 0.36 | quartz |
| 2.29 | 74.8 | 3561 | 3.96 | 0.39 | 12.3 | 0.35 | quartz |
| 2.50 | 68.5 | 2992 | 3.31 | 0.17 | 5.6 | 0.29 | quartz |
| 2.92 | 68.0 | 2935 | 2.96 | 0.18 | 4.8 | 0.26 | quartz |
| 3.13 | 67.4 | 2906 | 2.84 | 0.16 | 4.4 | 0.27 | quartz |
| 4.17 | 62.9 | 2557 | 2.10 | 0.04 | 1.8 | 0.23 | quartz |
| 6.25 | 59.5 | 2408 | 1.46 | 0 | 1.2 | 0.22 | quartz |

Some expected trends are evident from the above Tables 5 and 6, particularly for the thinner coating weights (Table 6). When coatings become thinner, the ratio of I₄₅₁/Iₚₕₒₛₚₕₒᵣ increases as seen in Table 6 but not in Table 5. Respective integrated areas of 411 nm and 451 nm emissions for the coating densities of 2.50 and 15.8 mg/cm² as examples are 23%-77% and 35%-65%, a modification expected from 40%-60% ratio measured for the pure discharge. With more blue light being included in the emission from slides, the CRI improves and the color temperature rises. Relative lumens calculated on the basis of emission spectra show an increase with decreasing coating thickness. For collecting the data that are presented in both tables, the same experimental conditions were used and therefore all the relative lumen values are normalized to the same number (corresponding to 10.2 mg/cm² in Table 5). The trend in lumen values is most likely caused by re-absorption of visible light generated in the phosphor layer itself as mentioned above.

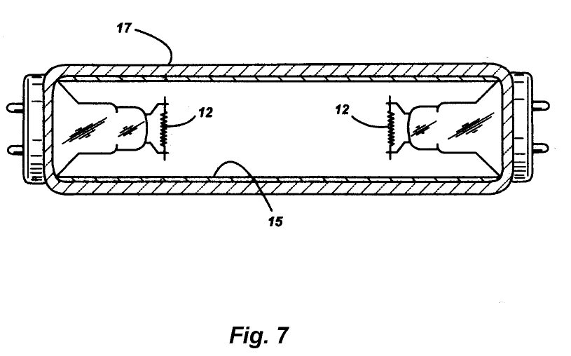

FIG. 7 is a cross-sectional illustration of an indium halide discharge lamp having a phosphor coating containing the phosphor blend of this invention. The lamp has a hermetically sealed glass envelope 17. The interior of the envelope 17 is filled with an inert gas such as argon or a mixture of argon and krypton at a low pressure, for example 1-3 mbar, and a small quantity of an indium halide, preferably indium(I) chloride (InCl). An electrical discharge is generated between electrodes 12 to excite the vapor to generate an indium emission. A phosphor coating 15 is applied to the interior surface of the envelope 17 to convert at least a portion of the radiation emitted by the low-pressure discharge into a desired wavelength range. The phosphor coating 15 contains the phosphor blend of this invention which is stimulated by the radiation emitted by the discharge to emit visible light, whereby the transmitted emission from the discharge and visible light emitted by the phosphor coating combine to yield lamp that emits a white light.

While there have been shown and described what are presently considered to be the preferred embodiments of the invention, it will be apparent to those skilled in the art that various changes and modifications can be made herein without departing from the scope of the invention as defined by the appended claims.

We claim:

1. A phosphor blend comprising a mixture of phosphor components wherein the weight fractions of the phosphor components are 0.15<X<0.85, 0.85>Z>0.15 and X+Z=1, and wherein X is Ca₈Mg(SiO₄)₄Cl₂:Eu and Z is Ca₂Si₅N₈:Eu.

2. A phosphor blend comprising a mixture of phosphor components wherein the weight fractions of the phosphor components are 0.15<Y<0.85, 0.85>Z>0.15 and Y+Z=1, and wherein Y is SrSi₂N₂O₂:Eu and Z is Ca₂Si₅N₈:Eu.

3. A phosphor blend comprising a mixture of phosphor components wherein the weight fractions of the phosphor components are 0.15<(X+Y)<0.85, 0.85>Z>0.15 and X+Y+Z=1, and wherein X is Ca₈Mg(SiO₄)₄Cl₂:Eu, Y is SrSi₂N₂O₂:Eu and Z is Ca₂Si₅N₈:Eu.

4. The phosphor blend of claim 3 wherein the weight fractions of the phosphor components are 0.25<Z<0.75, 0.75>(X+Y)>0.25, and 0.75(X)<Y<1.5(X).

5. The phosphor blend of claim 3 wherein the weight fractions of the phosphor components are 0.55<Z<0.75, 0.1<X<0.25, and 0.1<Y<0.25.

6. A phosphor blend comprising a mixture of components wherein the weight fractions of the phosphor components are 0.40<Z<0.65, 0.1<X<0.30, 0.1<Y<0.30, 0.01<W<0.15 and X+Y+Z+W=1, and wherein X is Ca₈Mg(SiO₄)₄Cl₂:Eu, Y is SrSi₂N₂O₂:Eu, Z is Ca₂Si₅N₈:Eu and W is a blue-emitting phosphor.

7. The phosphor blend of claim 6 wherein the blue-emitting phosphor is at least one of BaMgAl₁₀O₁₇:Eu, SrMgAl₁₀O₁₇:Eu, and Sr₅(PO₄)₆Cl:Eu²⁺.

8. The phosphor blend of claim 6 wherein the blue-emitting phosphor is BaMgAl₁₀O₁₇:Eu.

9. A lamp comprising a glass envelope enclosing a discharge space, the discharge space containing a indium halide and a buffer gas, electrodes for generating a discharge, and a phosphor coating on a surface of the envelope, the phosphor coating comprising one of the phosphor blends of claims 1 to 8.

10. The lamp of claim 9 wherein the indium halide is indium chloride.

11. The lamp of claim 10 wherein the lamp exhibits a CRI of greater than 80.

12. The lamp of claim 11 wherein the lamp has a correlated color temperature in a range of 3000K to 7000K.

13. The lamp of claim 12 wherein the correlated color temperature is from 3000K to 5500K.
